(19) United States
(12) Patent Application Publication
(10) Pub. No.: US 2012/0009332 A1
(43) Pub. Date: Jan. 12, 2012

(54) METHOD OF MANUFACTURING ORGANIC LIGHT-EMITTING DISPLAY DEVICE

(76) Inventors: Sang-Yeol Kim, Yongin-city (KR); Il-Seok Park, Yongin-city (KR); Kyul Han, Yongin-city (KR); Mu-Hyun Kim, Yongin-city (KR)

(21) Appl. No.: 13/180,454

(22) Filed: Jul. 11, 2011

(30) Foreign Application Priority Data
Jul. 12, 2010 (KR) 10-2010-0066991

(51) Int. Cl. B05D 5/06

(52) U.S. Cl. 427/66

(57) ABSTRACT

A method of manufacturing an organic light-emitting display device, which simplifies fabrication processes of the organic light-emitting display device and improves manufacturing yield. This method includes preparing a substrate that has a number of first regions and a second region surrounding the first regions. The substrate is conveyed into a chamber. An organic emission layer is formed in a direction on a surface of the substrate. A first metal layer is formed on the organic emission layer so as to correspond to the first regions, and the organic emission layer formed on the second region is removed.

### CLAIM OF PRIORITY

This application makes reference to, incorporates the same herein, and claims priority to and all benefits accruing under 35 U.S.C. §119 from an application earlier filed in the Korean Intellectual Property Office on Jul. 12, 2010 and there duly assigned Serial No. 10-2010-0066991.

### BACKGROUND

1. Field

Aspects of embodiments according to the present invention relate to a method of manufacturing an organic light-emitting display device.

2. Description of the Related Art

Organic light-emitting display devices have a larger viewing angle, better contrast characteristics, and a faster response rate than other display devices, and thus have drawn attention as a next-generation display device.

The above information disclosed in this Related Art section is only for enhancement of understanding of the background of the invention and therefore it may contain information that does not form the prior art that is already known to a person of ordinary skill in the art.

### SUMMARY

One or more aspects of embodiments according to the present invention provide a method of manufacturing an organic light-emitting display device, which may simplify manufacturing processes of the organic-light emitting display device and improve a production yield.

According to an aspect of embodiments according to the present invention, there is provided a method of manufacturing an organic light-emitting display device, the method may include: preparing a substrate that includes a plurality of first regions and a second region surrounding the plurality of first regions; conveying the substrate into a chamber; forming an organic emission layer in a direction on a surface of the substrate; forming a first metal layer on the organic emission layer so as to correspond to the first regions; and removing the organic emission layer formed on the second region.

The first metal layer may be a common electrode, and may protect the organic emission layer formed on the first regions when the organic emission layer formed on the second region is removed.

In the removing of the organic emission layer, the organic emission layer formed on the second region may be removed by a plasma etching process, an ultraviolet (UV)-ozone process, or a laser ablation process.

The method may further include covering the first metal layer by using a shielding plate, after forming the first metal layer and before removing the organic emission layer.

The shielding plate may cover the first metal layer and may expose the organic emission layer formed on the second region.

The shielding plate may be formed of a metal plate or a non-metal plate, and covers the first metal layer formed on the plurality of first regions.

In the removing of the organic emission layer, the organic emission layer formed on the second region in a state where the shielding plate may cover the first metal layer.

The shielding plate may be removed after removing the organic emission layer.

A second metal layer may be formed on the first metal layer after removing the shielding plate.

The second metal layer may be the common electrode.

The forming of the organic emission layer may be performed by using a thin film deposition assembly disposed in the chamber, and the organic emission layer may be formed on the substrate by a relative movement of the substrate with respect to the thin film deposition assembly.

The forming of the organic emission layer may be performed on the substrate continuously by a plurality of thin film deposition assemblies that are disposed in the chamber.

The thin film assembly may include: a deposition source that discharges a deposition material; a deposition source nozzle unit disposed at a side of the deposition source and including a plurality of deposition source nozzles arranged in a first direction; and a patterning slit sheet disposed opposite to the deposition source nozzle unit and having a plurality of patterning slits arranged in a second direction perpendicular to the first direction, wherein the deposition source, the deposition source nozzle unit, and the patterning slit sheet may be integrally formed as one body, and the thin film deposition assembly may be separated from the substrate, and deposition may be performed while the substrate or the thin film deposition assembly is moved relative to the other in the first direction.

The deposition source and the deposition source nozzle unit, and the patterning slit sheet may be integrally connected as one body by a connection member that guides flow of the deposition material.

The connection member may seal a space between the deposition source nozzle unit disposed at the side of the deposition source, and the patterning slit sheet.

The plurality of deposition source nozzles may be formed to be tilted at an angle.

The plurality of deposition source nozzles may include deposition source nozzles arranged in two rows formed in the first direction, and the deposition source nozzles in the two rows may be tilted to face each other.

The plurality of deposition source nozzles may include deposition source nozzles arranged in two rows formed in the first direction, the deposition source nozzles of a row located at a first side of the patterning slit sheet may be arranged to face a second side of the patterning slit sheet, and the deposition source nozzles of the other row located at the second side of the patterning slit sheet may be arranged to face the first side of the patterning slit sheet.

The thin film deposition assembly may include: a deposition source discharging a deposition material; a deposition source nozzle unit disposed at a side of the deposition source and including a plurality of deposition source nozzles arranged in a first direction; a patterning slit sheet disposed opposite to the deposition source nozzle unit and having a plurality of patterning slits arranged in the first direction; and a barrier plate assembly comprising a plurality of barrier plates that are disposed between the deposition source nozzle unit and the patterning slit sheet in the first direction, and partition a space between the deposition source nozzle unit and the patterning slit sheet into a plurality of sub-deposition spaces, wherein the thin film deposition assembly may be separated from the substrate, and deposition may be performed while the substrate or the thin film deposition assembly is moved relative to the other.

Each of the plurality of barrier plates may extend in a second direction substantially perpendicular to the first direction.

The barrier plate assembly may include a first barrier plate assembly including a plurality of first barrier plates, and a second barrier plate assembly including a plurality of second barrier plates.

Each of the first barrier plates and each of the second barrier plates may extend in the second direction substantially perpendicular to the first direction.

The plurality of first barrier plates may be arranged to respectively correspond to the plurality of second barrier plates.

The deposition source and the barrier plate assembly may be separated from each other.

The barrier plate assembly and the patterning slit sheet may be separated from each other.

### BRIEF DESCRIPTION OF THE DRAWINGS

A more complete appreciation of the present invention, and many aspects thereof, will be readily apparent as the same becomes better understood by reference to the following detailed description when considered in conjunction with the accompanying drawings in which like reference symbols indicate the same or similar components, wherein:

FIG. 1 is a schematic block diagram of view of a thin film deposition apparatus used to manufacture an organic light-emitting display device according to an embodiment of the present invention;

FIG. 2 illustrates a modified example of the thin film deposition apparatus of FIG. 1;

FIG. 3 is a schematic view of an example of an electrostatic chuck;

FIG. 4 is a cross-sectional view of an organic light-emitting display device manufactured by using a thin film deposition apparatus, according to an embodiment of the present invention.

FIGS. 5 through 10 are schematic plan views illustrating a method of manufacturing an organic light-emitting display device, according to an embodiment of the present invention;

FIG. 11 is a perspective view of a thin film deposition assembly according to an embodiment of the present invention;

FIG. 12 is a schematic sectional side view of the thin film deposition assembly of FIG. 11, according to an embodiment of the present invention;

FIG. 13 is a schematic plan view of the thin film deposition assembly of FIG. 11, according to an embodiment of the present invention;

FIG. 14 is a perspective view of a thin film deposition assembly according to another embodiment of the present invention;

FIG. 15 is a perspective view of a thin film deposition assembly according to another embodiment of the present invention;

FIG. 16 is a perspective view of a thin film deposition assembly according to another embodiment of the present invention;

FIG. 17 is a schematic sectional side view of the thin film deposition assembly of FIG. 16, according to an embodiment of the present invention;

FIG. 18 is a schematic plan view of the thin film deposition assembly of FIG. 16, according to an embodiment of the present invention; and

FIG. 19 is a perspective view of a thin film deposition assembly according to another embodiment of the present invention.

### DETAILED DESCRIPTION

The present invention will now be described more fully with reference to the accompanying drawings in which exemplary embodiments of the invention are shown. In the drawings, the thicknesses of layers and regions are exaggerated for clarity. Like reference numerals in the drawings denote like elements, and thus their description will be omitted.

Recognizing that sizes and thicknesses of constituent members shown in the accompanying drawings are arbitrarily given for better understanding and ease of description, the present invention is not limited to the illustrated sizes and thicknesses.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. Alternatively, when an element is referred to as being “directly on” another element, there are no intervening elements present.

In order to clarify the present invention, some of the elements extrinsic to the description are omitted from the details of this description, and like reference numerals refer to like elements throughout the specification.

In several exemplary embodiments, constituent elements having the same configuration are representatively described in a first exemplary embodiment by using the same reference numeral and only constituent elements other than the constituent elements described in the first exemplary embodiment will be described in other embodiments.

Organic light-emitting display devices generally have a stacked structure including an anode, a cathode, and an emission layer interposed between the anode and the cathode. The devices display images in color when holes and electrons, injected respectively from the anode and the cathode, recombine in the emission layer and thus light is emitted. However, it is difficult to achieve high light-emission efficiency with such a structure, and thus intermediate layers, including an electron injection layer, an electron transport layer, a hole transport layer, a hole injection layer, etc., are optionally additionally interposed between the emission layer and each of the electrodes.

Also, it is practically very difficult to form fine patterns in organic thin films such as the emission layer and the intermediate layers, and red, green, and blue light-emission efficiency varies according to the organic thin films. For these reasons, it is not easy to form an organic thin film pattern on a large substrate, such as a mother glass having a size of 5G or more, by using a conventional thin film deposition apparatus, and thus it is difficult to manufacture large organic light-emitting display devices having satisfactory driving voltage, current density, brightness, color purity, light-emission efficiency, life-span characteristics. Thus, there is a demand for improvement in this regard.

An organic light-emitting display device may include intermediate layers, including an emission layer disposed between a first electrode and a second electrode that are arranged opposite to each other. The electrodes and the intermediate layers may be formed via various methods, one of which is a deposition method. When an organic light-emitting display device is manufactured using the deposition method, a fine metal mask (FMM) having the same pattern as a thin layer to be formed is disposed to closely contact a substrate, and a thin film material is deposited over the FMM in order to form the thin layer having the desired pattern.

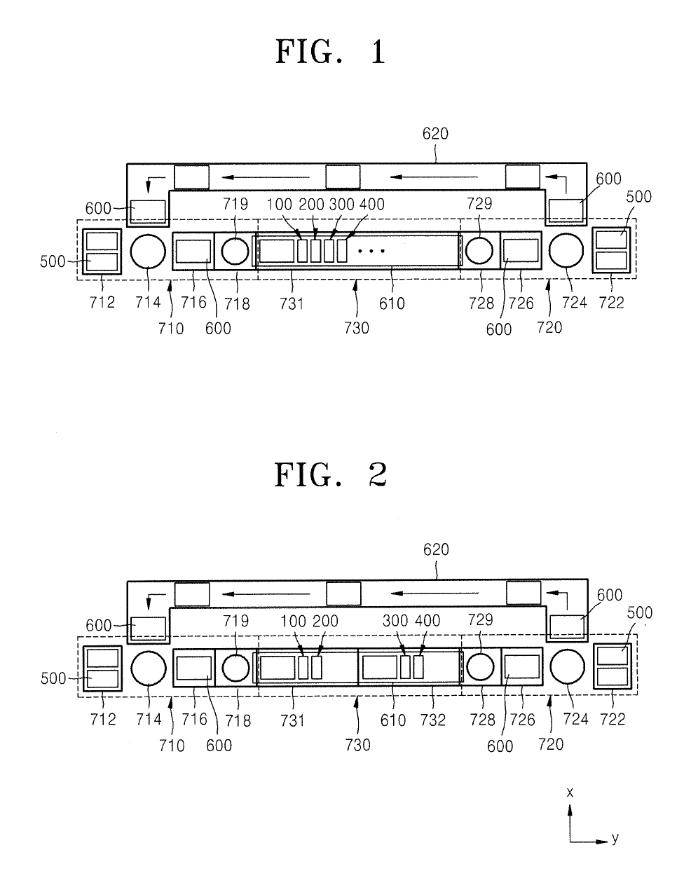

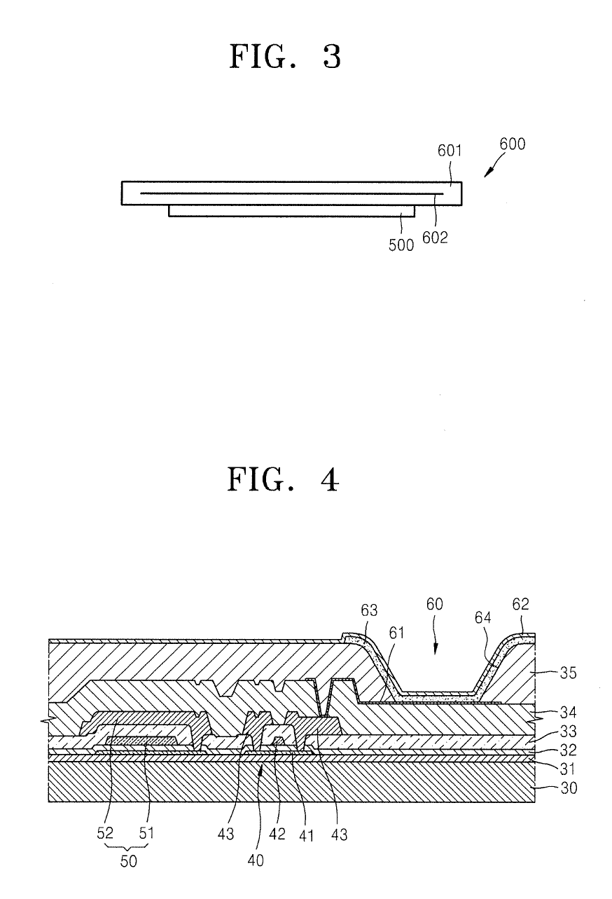

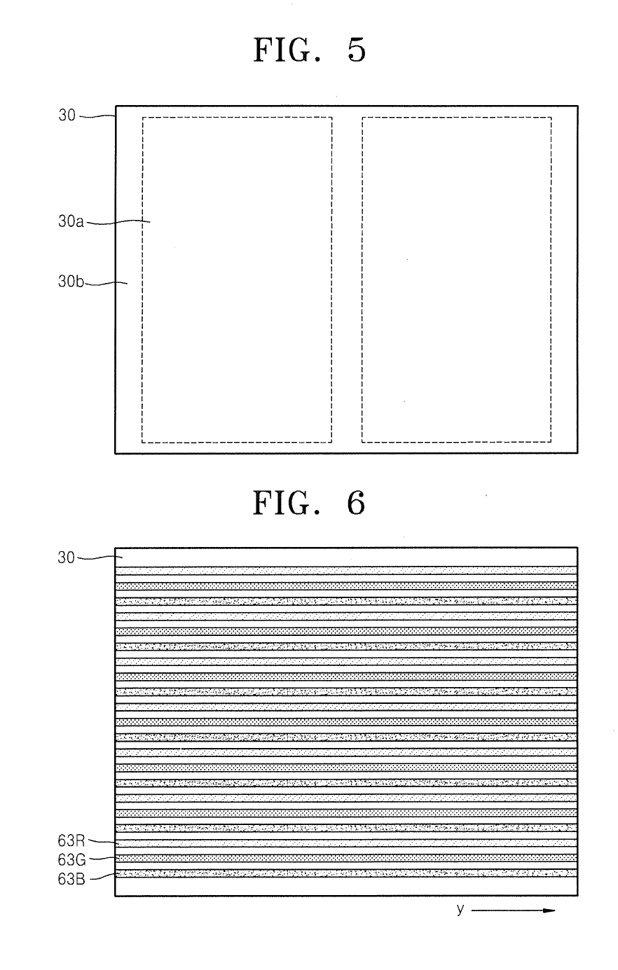

FIG. 1 is a schematic block diagram of a thin film deposition apparatus used in manufacturing processes of an organic light-emitting display device according to an embodiment of the present invention. FIG. 2 illustrates a modified example of the thin film deposition apparatus of FIG. 1. FIG. 3 is a schematic view of an example of an electrostatic chuck 600 included in the thin film deposition apparatus of FIG. 1.

Referring to FIG. 1, the thin film deposition apparatus includes a loading unit 710, a deposition unit 730, an unloading unit 720, a first conveyer unit 610, and a second conveyer unit 620.

The loading unit 710 includes a first rack 712, a transport robot 714, a transport chamber 716, and a first inversion chamber 718.

A plurality of substrates 500 onto which a deposition material is not applied are stacked up on the first rack 712. The transport robot 714 picks up one of the substrates 500 from the first rack 712, disposes it on the electrostatic chuck 600 transferred by the second conveyor unit 620, and moves the electrostatic chuck 600 on which the substrate 500 is disposed into the transport chamber 716.

The first inversion chamber 718 is disposed adjacent to the transport chamber 718. The first inversion chamber 718 includes a first inversion robot 719 that inverts the electrostatic chuck 600 and then loads it into the first conveyer unit 610 of the deposition unit 730.

Referring to FIG. 3, the electrostatic chuck 600 may include an electrode 602 embedded in a main body 601 formed of ceramic, wherein the electrode 602 is supplied with power. The electrostatic chuck 600 may fix the substrate 500 on a surface of the main body 601 as a high voltage is applied to the electrode 602.

Referring to FIG. 1, the transport robot 714 places one of the substrates 500 on the surface of the electrostatic chuck 600, and the electrostatic chuck 600 on which the substrate 500 is disposed is loaded into the transport chamber 719. The first inversion robot 719 inverts the electrostatic chuck 600 so that the substrate 500 is turned upside down in the deposition unit 730.

The unloading unit 720 is constituted to operate in an opposite manner to the loading unit 710 described above. That is, a second inversion robot 729 in a second inversion chamber 728 inverts the electrostatic chuck 600 and the substrate 500, which has passed through the deposition unit 730, and then moves the electrostatic chuck 600 on which the substrate 500 is disposed into an ejection chamber 726. Then, an ejection robot 724 removes the electrostatic chuck 600 on which the substrate 500 is disposed from the ejection chamber 726, separates the substrate 500 from the electrostatic chuck 600, and then loads the substrate 500 into the second rack 722. The electrostatic chuck 600 separated from the substrate 500 is returned back into the loading unit 710 via the second conveyer unit 620.

However, the present invention is not limited to the above description. For example, when disposing the substrate 500 on the electrostatic chuck 600, the substrate 500 may be fixed onto a bottom surface of the electrostatic chuck 600 and then moved into the deposition unit 730. In this case, for example, the first inversion chamber 718 and the first inversion robot 719, and the second inversion chamber 728 and the second inversion robot 729 are not required.

The deposition unit 730 may include at least one deposition chamber. As illustrated in FIG. 1, the deposition unit 730 may include a first chamber 731. In this case, first to four thin film deposition assemblies 100, 200, 300, and 400 may be disposed in the first chamber 731. Although FIG. 1 illustrates that a total of four thin film deposition assemblies, i.e., the first to fourth thin film deposition assemblies 100 to 400, are installed in the first chamber 731, the total number of thin film deposition assemblies that may be installed in the first chamber 731 may vary according to a deposition material and deposition conditions. The first chamber 731 is maintained in a vacuum state during a deposition process.

In the thin film deposition apparatus illustrated in FIG. 2, a deposition unit 730 may include a first chamber 731 and a second chamber 732 that are connected to each other. In this case, first and second thin film deposition assemblies 100 and 200 may be disposed in the first chamber 731, and third and fourth thin film deposition assemblies 300 and 400 may be disposed in the second chamber 732. In this regard, the number of chambers disposed in the first and second chambers 731 and 732 may be increased.

In the embodiment illustrated in FIG. 1, the electrostatic chuck 600 on which the substrate 500 is disposed is moved at least to the deposition unit 730, for example, may be moved sequentially to the loading unit 710, the deposition unit 730, and the unloading unit 720, by the first conveyor unit 610. The electrostatic chuck 600 that is separated from the substrate 500 in the unloading unit 720 is moved back to the loading unit 710 by the second conveyor unit 620.

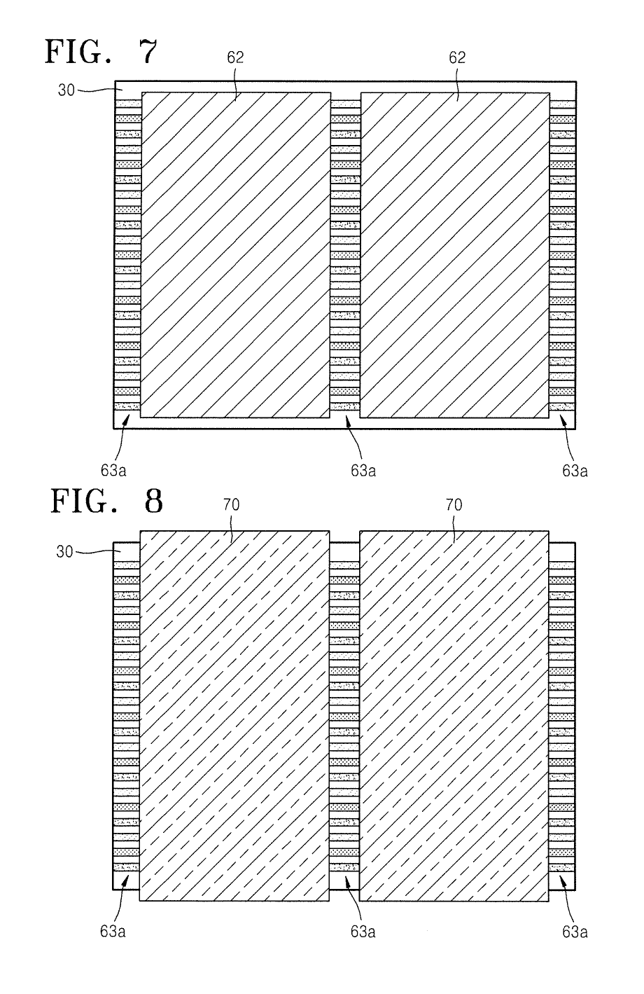

FIG. 4 is a cross-sectional view of an active matrix organic light-emitting display device fabricated by using the thin film deposition apparatus illustrated in FIG. 1 or FIG. 2, according to an embodiment of the present invention.

Referring to FIG. 4, the active matrix organic light-emitting display device according to the current embodiment is formed on a substrate 30. The substrate 30 may be formed of a transparent material, for example, glass, plastic or metal. An insulating layer 31, such as a buffer layer, is formed on an entire surface of the substrate 30.

A thin film transistor (TFT) 40, a capacitor 50, and an organic light-emitting diode (OLED) 60 are disposed on the insulating layer 31, as illustrated in FIG. 4.

A semiconductor active layer 41 is formed on an upper surface of the insulating layer 31 in a pattern (e.g., a predetermined pattern). A gate insulating layer 32 is formed to cover the semiconductor active layer 41. The semiconductor active layer 41 may include a p-type or n-type semiconductor material.

A gate electrode 42 of the TFT 40 may be formed in a region of the gate insulating layer 32 corresponding to the semiconductor active layer 41. An interlayer insulating layer 33 may be formed to cover the gate electrode 42. After forming the interlayer insulating layer 33, the interlayer insulating layer 33 and the gate insulating layer 32 may be etched by, for example, dry etching, to form a contact hole exposing parts of the semiconductor active layer 41.

A source/drain electrode 43 may be formed on the interlayer insulating layer 33 to contact the exposed part of the semiconductor active layer 41 through the contact hole. A passivation layer 34 may be formed to cover the source/drain electrode 43, and may be etched to expose a part of the drain electrode 43. An insulating layer (not shown) may be further formed on the passivation layer 34 so as to planarize the passivation layer 34.

In addition, the OLED 60 displays image information (e.g., predetermined image information) by emitting red, green, or blue light as current flows. The OLED 60 may include a first electrode 61 disposed on the passivation layer 34. The first electrode 61 may be electrically connected to the drain electrode 43 of the TFT 40.

A pixel defining layer 35 is formed to cover the first electrode 61. An opening 64 is formed in the pixel defining layer 35, and an organic emission layer 63 is formed in a region defined by the opening 64. A second electrode 62 is formed on the organic emission layer 63.

The pixel defining layer 35, which defines individual pixels, may be formed of an organic material. The pixel defining layer 35 may also planarize the surface of a region of the substrate 30 in which the first electrode 61 is formed, and in particular, may planarize the surface of the passivation layer 34.

The first electrode 61 and the second electrode 62 are insulated from each other, and respectively apply voltages of opposite polarities to the organic emission layer 63 to induce light emission.

The intermediate layer 63 may be formed of a low-molecular weight organic material or a high-molecular weight organic material. When a low-molecular weight organic material is used, the intermediate layer 63 may have a single or multi-layer structure including at least one selected from the group consisting of a hole injection layer (HIL), a hole transport layer (HTL), an emission layer (EML), an electron transport layer (ETL), and an electron injection layer (EIL). Examples of available organic materials may include copper phthalocyanine (CuPc), N,N′-di(naphthalene-1-yl)-N,N′-diphenyl-benzidine (NPB), tris-8-hydroxyquinoline aluminum (Alq3), and the like. Such a low-molecular weight organic material may be deposited by vacuum deposition using one of the thin film deposition apparatuses described above with reference to FIGS. 1 through 2. This will be described later.

A second electrode 62 may be formed on the organic emission layer 63.

The first electrode 61 may function as an anode, and the second electrode 62 may function as a cathode. Alternatively, the first electrode 61 may function as a cathode, and the second electrode 62 may function as an anode. The first electrode 61 may be patterned to correspond to individual pixel regions, and the second electrode 62 may be formed to cover all the pixels.

The first electrode 61 may be formed as a transparent electrode or a reflective electrode. Such a transparent electrode may be formed of indium tin oxide (ITO), indium zinc oxide (IZO), zinc oxide (ZnO), or indium oxide (In₂O₃). Such a reflective electrode may be formed by forming a reflective layer from silver (Ag), magnesium (Mg), aluminum (Al), platinum (Pt), palladium (Pd), gold (Au), nickel (Ni), neodymium (Nd), iridium (Ir), chromium (Cr) or a compound thereof and forming a layer of ITO, IZO, ZnO, or In₂O₃ on the reflective layer. The first electrode 61 may be formed by forming a layer by, for example, sputtering, and then patterning the layer by, for example, photolithography.

The second electrode 62 may also be formed as a transparent electrode or a reflective electrode. When the second electrode 62 is formed as a transparent electrode, the second electrode 62 functions as a cathode. To this end, such a transparent electrode may be formed by depositing a metal having a low work function, such as lithium (Li), calcium (Ca), lithium fluoride/calcium (LiF/Ca), lithium fluoride/aluminum (LiF/Al), aluminum (Al), silver (Ag), magnesium (Mg), or a compound thereof on a surface of the organic emission layer 63 and forming an auxiliary electrode layer or a bus electrode line thereon from ITO, IZO, ZnO, In₂O₃, or the like. When the second electrode layer 62 is formed as a reflective electrode, the reflective layer may be formed by depositing Li, Ca, LiF/Ca, LiF/Al, Al, Ag, Mg, or a compound thereof. The second electrode 62 may be formed by using the same deposition method as used to form the organic emission layer 63 described above.

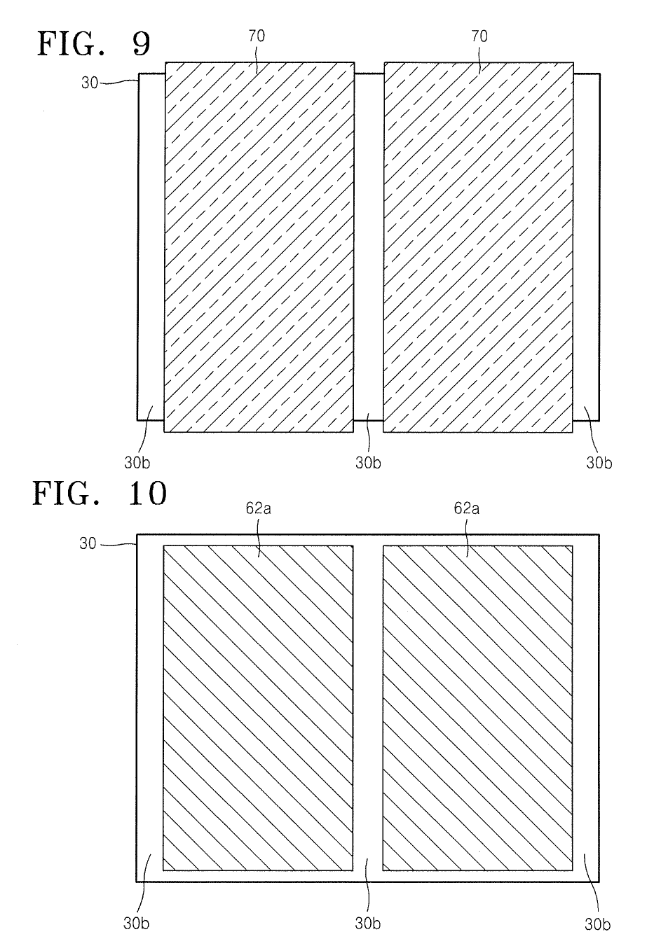

FIGS. 5 through 10 are plan views illustrating processes of forming the organic emission layer 63.

First, FIG. 5 is a plan view of the substrate 30 before being conveyed to the deposition unit 730. Referring to FIG. 5, the substrate 30 may be divided into a plurality of first regions 30a and a second region 30b surrounding the plurality of first regions 30a. The capacitor 50, the TFT 40, the passivation layer 34, the first electrode 61, and the pixel defining layer 35 in which the opening 64 is formed, are formed on the first regions 30a. The capacitor 50, the TFT 40, and the first electrode 61 are not formed on the second region 30b. An organic layer such as the pixel defining layer 35 may be formed on the second region 30b, however, other layers may not be formed on the second region 30b.

When the substrate 30 shown in FIG. 5 is inserted into the chambers 721 and 732 of the deposition unit 730 illustrated in FIG. 1 or FIG. 2, organic emission layers 63R, 63G, and 63B are formed on the substrate 30 by the thin film deposition assemblies 100, 200, 300, and 400, as shown in FIG. 6. The organic emission layers 63R, 63G, and 63B may be formed on the second region 30b, as well as the first regions 30a of the substrate 30.

Next, as shown in FIG. 7, a first metal layer 62 is formed on the substrate 30, on which the organic emission layers 63R, 63G, and 63B are formed. The first metal layer 62 may be formed on the organic emission layers 63R, 63G, and 63B so as to correspond to the first regions 30a. That is, the first metal layer 62 is not formed on an organic emission layer 63a that is formed on the second region 30b. If a metal deposition device (not shown), for example, a sputtering device, is disposed in the deposition unit 730, the first metal layer 62 may be formed inside the deposition unit 730.

The first metal layer 62 performs as a common electrode, that is, performs the same function as the second electrode 62 illustrated in FIG. 4.

Then, as shown in FIG. 8, a shielding plate 70 is disposed on the first metal layer 62. The shielding plate 70 may cover the first metal layer 62 so as not to expose the first metal layer 62. Although the shielding plate 70 may be disposed on the first metal layer 62 so as to completely cover the first metal layer 62, the shielding plate 70 does not cover the organic emission layer 62a formed on the second region 30b. That is, the organic emission layer 63a is not covered by the shielding plate 70, but is exposed to outside.

Next, as shown in FIG. 9, the organic emission layer 63a formed on the second region 30b is removed. The organic emission layer 63a may be removed by a plasma etching process, a UV-ozone process, or a laser ablation process. The shielding plate 70 may protect the organic emission layers 63R, 63G, and 63B not to be damaged while the organic emission layer 63a is removed. The shielding plate 70 may be formed of a metal plate or a non-metal plate that is not damaged by the plasma etching process, the UV-ozone process, or the laser ablation process.

After removing the organic emission layer 63a, the shielding plate 70 may be removed from the first metal layer 62. After that, a bonding member (not shown) may be applied on the second region 30b, from which the organic emission layer 63a is removed, and a sealing substrate (not shown) and the substrate 30 are bonded to each other by the bonding member.

According to the method of fabricating the organic light-emitting display device of another embodiment, the organic emission layer 63a is removed, the shielding plate 70 is removed from the first metal layer 62, and after that, a second metal layer 62a is formed on the first metal layer 62 as shown in FIG. 10. The second metal layer 62a is formed to cover the first metal layer 62, but is not formed on the second region 30b. The second metal layer 62a may perform as the common electrode together with the first metal layer 62.

As described above, the organic emission layer 63a formed on the second region 30b during an in-line deposition process may be removed by using the plasma, UV-ozone, or the laser so that an additional complex device is not necessary in the chamber, and thus, a fabrication yield of the organic light-emitting display device may be improved.

Hereinafter, an embodiment of the thin film deposition assembly 100 disposed in the first chamber 731 will be described.

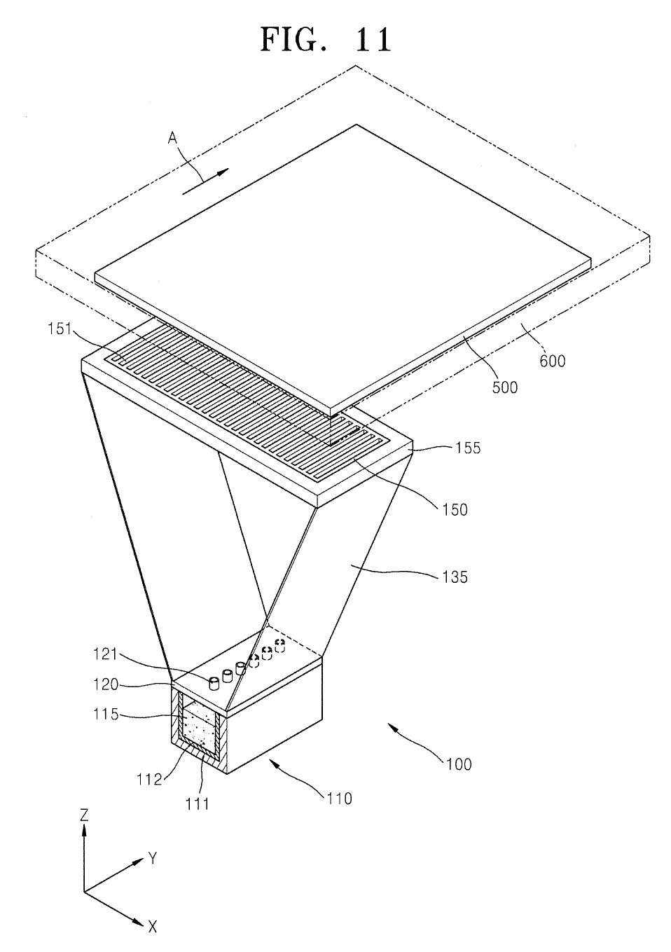

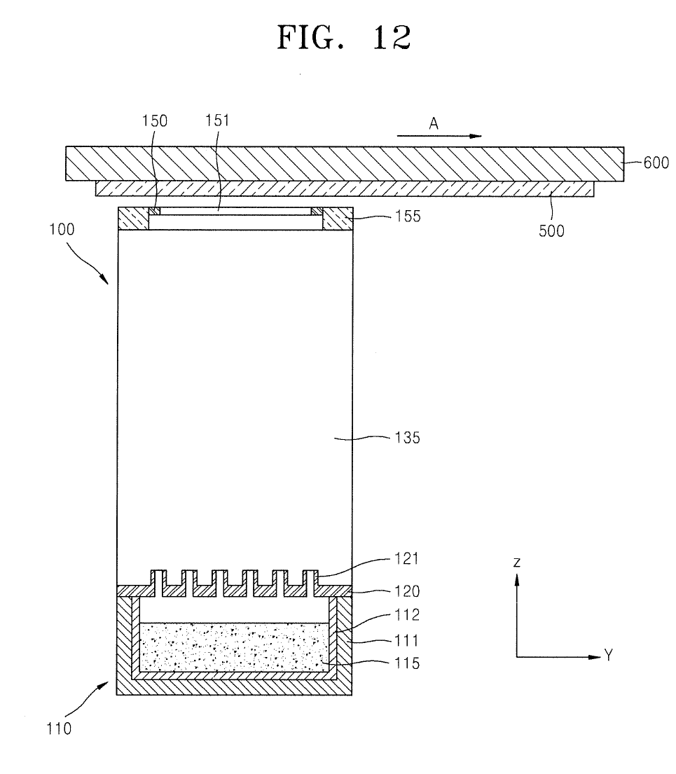

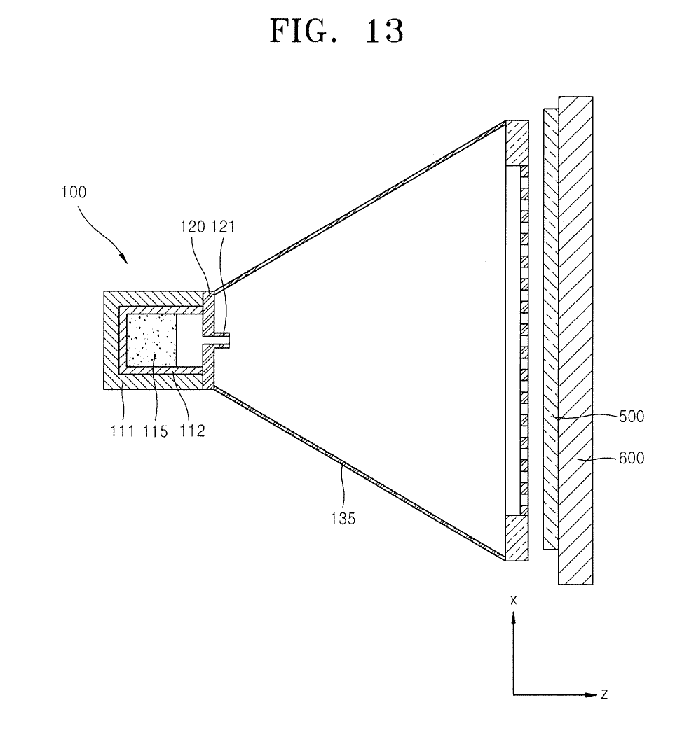

FIG. 11 is a schematic perspective view of the thin film deposition assembly 100 according to an embodiment of the present invention, FIG. 12 is a schematic sectional side view of the thin film deposition assembly 100 of FIG. 11, and FIG. 13 is a schematic sectional plan view of the thin film deposition assembly 100 of FIG. 11.

Referring to FIGS. 11 through 13, the thin film deposition assembly 100 according to the current embodiment of the present invention includes a deposition source 110, a deposition source nozzle unit 120, and a patterning slit sheet 150.

In particular, in order to deposit a deposition material 115 that is emitted from the deposition source 110 and is discharged through the deposition source nozzle unit 120 and the patterning slit sheet 150, onto a substrate 500 in a desired pattern, the first chamber 731 is maintained in a high-vacuum state as in a deposition method using a fine metal mask (FMM). In addition, the temperature of the patterning slit sheet 150 is sufficiently lower than the temperature of the deposition source 110. In this regard, the temperature of the patterning slit sheet 150 may be about 100° C. or less. The temperature of the patterning slit sheet 150 should be sufficiently low so as to reduce thermal expansion of the patterning slit sheet 150.

The substrate 500, which is a deposition target substrate on which a deposition material 115 is to be deposited, is disposed in the first chamber 731. The substrate 500 may be a substrate for flat panel displays. A large substrate, such as a mother glass, for manufacturing a plurality of flat panel displays, may be used as the substrate 500. Other substrates may also be employed.

In the current embodiment of the present invention, deposition may be performed while the substrate 500 or the thin film deposition assembly 100 is moved relative to the other.

In particular, in the conventional FMM deposition method, the size of the FMM is equal to the size of a substrate. Thus, the size of the FMM is increased as the substrate becomes larger. However, it is neither straightforward to manufacture a large FMM nor to extend an FMM to be accurately aligned with a pattern.

In order to overcome this problem, in the thin film deposition assembly 100 according to the current embodiment of the present invention, deposition may be performed while the thin film deposition assembly 100 or the substrate 500 is moved relative to the other. In other words, deposition may be continuously performed while the substrate 500, which is disposed such as to face the thin film deposition assembly 100, is moved in a Y-axis direction. In other words, deposition may be performed in a scanning manner while the substrate 500 is moved in a direction of arrow A in FIG. 11.

In the thin film deposition assembly 100 according to the current embodiment of the present invention, the patterning slit sheet 150 may be significantly smaller than a FMM used in a conventional deposition method. In other words, in the thin film deposition assembly 100 according to the current embodiment of the present invention, deposition may be continuously performed, i.e., in a scanning manner while the substrate 500 is moved in the Y-axis direction. Thus, lengths of the patterning slit sheet 150 in the X-axis and Y-axis directions may be less (e.g., significantly less) than the lengths of the substrate 500 in the X-axis and Y-axis directions. As described above, since the patterning slit sheet 150 may be formed to be smaller (e.g., significantly smaller) than a FMM used in a conventional deposition method, it is relatively easy to manufacture the patterning slit sheet 150 used in the present invention. In other words, using the patterning slit sheet 150, which is smaller than a FMM used in a conventional deposition method, is more convenient in all processes, including etching and other subsequent processes, such as precise extension, welding, moving, and cleaning processes, compared to the conventional deposition method using the larger FMM. This is more advantageous for a relatively large display device.

The deposition source 110 that contains and heats the deposition material 115 is disposed at an opposite side of the chamber to a side at which the substrate 500 is disposed. While being vaporized in the deposition source 110, the deposition material 115 may be deposited on the substrate 500.

In detail, the deposition source 110 includes a crucible 112 that is filled with the deposition material 115, and a cooling block 111 that heats the crucible 112 to vaporize the deposition material 115, which is contained in the crucible 112, towards a side of the crucible 111, and in particular, towards the deposition source nozzle unit 120. The cooling block 111 prevents radiation of heat from the crucible 112 outside, i.e., into the first chamber 731. The cooling block 111 may include a heater (not shown) that heats the crucible 111.

The deposition source nozzle unit 120 may be disposed at a side of the deposition source 110, and in particular, at the side of the deposition source 110 facing the substrate 500. The deposition source nozzle unit 120 includes a plurality of deposition source nozzles 121 arranged at equal intervals in the Y-axis direction, i.e., a scanning direction of the substrate 500. The deposition material 110 that is vaporized in the deposition source 110, passes through the deposition source nozzle unit 120 towards the substrate 500 that is the deposition target substrate. As described above, when the deposition source nozzle unit 120 includes the plurality of deposition source nozzles 121 arranged in the Y-axis direction, that is, the scanning direction of the substrate 500, the size of a pattern formed of the deposition material discharged through the patterning slits 151 of the patterning slit sheet 150 may be affected by the size of one of the deposition source nozzles 121 (since there is only one line of deposition nozzles in the X-axis direction), and thus no shadow zone may be formed on the substrate 500. In addition, since the plurality of deposition source nozzles 121 are arranged in the scanning direction of the substrate 400, even if there is a difference in flux between the deposition source nozzles 921, the difference may be compensated for and deposition uniformity may be maintained constant (or substantially constant).

The patterning slit sheet 150 and a frame 955 in which the patterning slit sheet 155 is bound are disposed between the deposition source 110 and the substrate 500. The frame 155 may be formed in a lattice shape, similar to a window frame. The patterning slit sheet 150 has a plurality of patterning slits 151 arranged in the X-axis direction. The deposition material 115 that is vaporized in the deposition source 110, passes through the deposition source nozzle unit 120 and the patterning slit sheet 150 towards the substrate 500. The patterning slit sheet 150 may be manufactured by etching, which may be the same method as used in a conventional method of manufacturing an FMM, and in particular, a striped FMM. In this regard, the total number of patterning slits 151 may be greater than the total number of deposition source nozzles 121.

In addition, the deposition source 110 and the deposition source nozzle unit 120 coupled to the deposition source 110 are disposed to be separated from the patterning slit sheet 150 by a distance (e.g., a predetermined distance). Alternatively, the deposition source 110 and the deposition source nozzle unit 120 coupled to the deposition source 110 may be connected to the patterning slit sheet 150 by a first connection member 135. That is, the deposition source 110, the deposition source nozzle unit 120, and the patterning slit sheet 150 may be integrally formed as one body by being connected to each other via the first connection member 135. The first connection member 135 guides the deposition material 115, which may be discharged through the deposition source nozzles 121, to move straight, not to flow in the X-axis direction. In FIGS. 11 through 13, the first connection members 135 are formed on left and right sides of the deposition source 110, the deposition source nozzle unit 120, and the patterning slit sheet 150 to guide the deposition material 115 not to flow in the X-axis direction; however, aspects of the present invention are not limited thereto. That is, the first connection member 135 may be formed as a sealed box to guide flow of the deposition material 115 both in the X-axis and Y-axis directions.

As described above, the thin film deposition assembly 100 according to the current embodiment of the present invention performs deposition while being moved relative to the substrate 500. In order to move the thin film deposition assembly 100 relative to the substrate 500, the patterning slit sheet 150 may be separated from the substrate 500 by a distance (e.g., a predetermined distance).

In particular, in the conventional deposition method using a FMM, deposition may be performed with the FMM in close contact with a substrate in order to prevent formation of a shadow zone on the substrate. However, when the FMM is used in close contact with the substrate, the contact may cause defects. In addition, in the conventional deposition method, the size of the mask has to be the same as the size of the substrate since the mask cannot be moved relative to the substrate. Thus, the size of the mask has to be increased as display devices become larger. However, it is not easy to manufacture such a large mask.

In order to overcome this problem, in the thin film deposition assembly 100 according to the current embodiment of the present invention, the patterning slit sheet 150 is disposed to be separated from the substrate 500 by a distance (e.g., a predetermined distance).

As described above, according to embodiments of the present invention, a mask may be formed to be smaller than a substrate, and deposition may be performed while the mask is moved relative to the substrate. Thus, the mask can be easily manufactured. In addition, defects caused due to the contact between the substrate and the FMM, which occur in the conventional deposition method, may be prevented. Furthermore, since it is unnecessary to dispose the FMM in close contact with the substrate during a deposition process, the manufacturing time may be reduced.

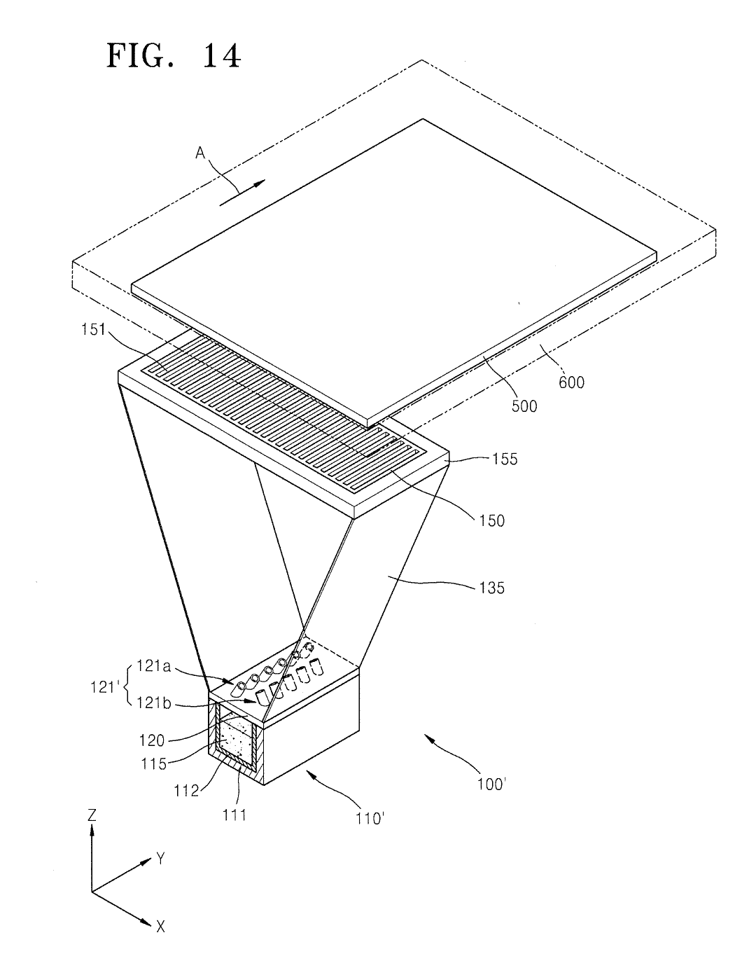

FIG. 14 is a perspective view of a thin film deposition assembly according to another embodiment of the present invention. Referring to FIG. 10, the thin film deposition assembly 100′ according to the current embodiment of the present invention includes a deposition source 110′, a deposition source nozzle unit 120′, and a patterning slit sheet 150. In particular, the deposition source 110′ includes a crucible 112 that may be filled with the deposition material 115, and a cooling block 112 that heats the crucible 112 to vaporize the deposition material 115, which is contained in the crucible 111, so as to move the vaporized deposition material 115 towards the deposition source nozzle unit 120′. The deposition source nozzle unit 120′ is disposed at a side of the deposition source 110′. The deposition source nozzle unit 120′ includes a plurality of deposition source nozzles 121′ arranged in the Y-axis direction. The patterning slit sheet 150 and a frame 155 are further disposed between the deposition source 110′ and the substrate 500. The patterning slit sheet 150 has a plurality of patterning slits 151 arranged in the X-axis direction. In addition, the deposition source 110′ and the deposition source nozzle unit 120′ may be connected to the patterning slit sheet 150 by a first connection member 135.

In the current embodiment, a plurality of deposition source nozzles 121′ formed on the deposition source nozzle unit 120′ are tilted at an angle (e.g., a predetermined angle), unlike the thin film deposition assembly described with reference to FIGS. 10 through 13. In more detail, the deposition source nozzles 121′ may include deposition source nozzles 121a and 121b arranged in respective rows. The deposition source nozzles 121a and 121b may be arranged in respective rows to alternate in a zigzag pattern. The deposition source nozzles 121a and 121b may be tilted at a predetermined angle on an XZ plane.

In the current embodiment of the present invention, the deposition source nozzles 121a and 121b are arranged to tilt at an angle (e.g., a predetermined angle) to each other. The deposition source nozzles 121a in a first row and the deposition source nozzles 121b in a second row may tilt to face each other. That is, the deposition source nozzles 121a of the first row in a left part of the deposition source nozzle unit 120′ are arranged to face a right side portion of the patterning slit sheet 150, and the deposition source nozzles 121b of the second row in a right part of the deposition source nozzle unit 120′ are arranged to face a right side portion of the patterning slit sheet 150.

Due to the structure of the thin film deposition assembly 100′ according to the current embodiment, the deposition of the deposition material 115 may be adjusted to lessen a thickness variation between the center and the end portions of the substrate 500 and improve thickness uniformity of the deposition film. Moreover, utilization efficiency of the deposition material 115 may also be improved.

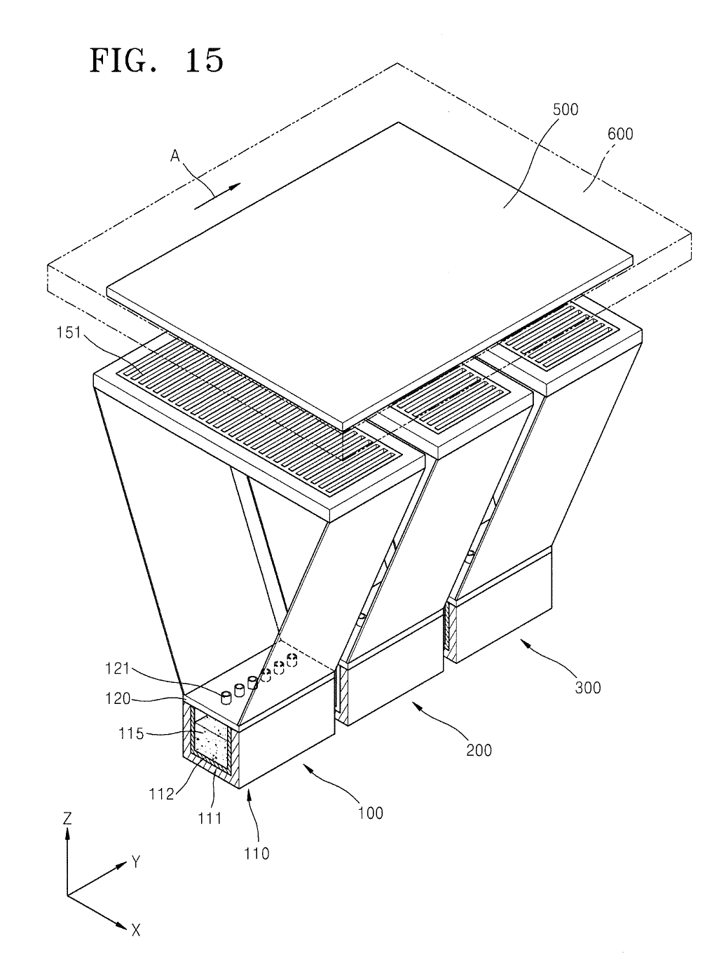

FIG. 15 is a perspective view of a thin film deposition assembly according to another embodiment of the present invention. Referring to FIG. 15, the thin film deposition assembly according to the current embodiment of the present invention includes a plurality of thin film deposition assemblies, each of which has the structure of the thin film deposition assembly 100 illustrated in FIGS. 11 through 13. In other words, the thin film deposition assembly according to the current embodiment of the present invention may include a multi-deposition source that simultaneously discharges deposition materials for forming an R emission layer, a G emission layer, and a B emission layer.

In particular, the thin film deposition assembly according to the current embodiment of the present invention includes a first thin film deposition assembly 100, a second thin film deposition assembly 200, and a third thin film deposition assembly 300. Each of the first thin film deposition assembly 100, the second thin film deposition assembly 200, and the third thin film deposition assembly 300 has the same structure as the thin film deposition assembly described with reference to FIGS. 11 through 13, and thus a detailed description thereof will not be provided here.

The deposition sources 110 of the first thin film deposition assembly 100, the second thin film deposition assembly 200 and the third thin film deposition assembly 300 may contain different deposition materials, respectively. For example, the first thin film deposition assembly 100 may contain a deposition material for forming the R emission layer, the second thin film deposition assembly 200 may contain a deposition material for forming the G emission layer, and the third thin film deposition assembly 300 may contain a deposition material for forming the B emission layer.

In other words, in a conventional method of manufacturing an organic light-emitting display device, a separate chamber and mask are used to form each color emission layer. However, when the thin film deposition assembly according to the current embodiment of the present invention is used, the R emission layer, the G emission layer and the B emission layer may be formed concurrently (e.g., at the same time) with a single multi-deposition source. Thus, the time taken to manufacture the organic light-emitting display device may be reduced (e.g., sharply reduced). In addition, the organic light-emitting display device may be manufactured with a reduced number of chambers, so that equipment costs may be reduced (e.g., markedly reduced) also.

Although not specifically shown in the drawings, the patterning slit sheets of the first thin film deposition assembly 100, the second thin film deposition assembly 200, and the third thin film deposition assembly 300 may be arranged to be offset by a constant distance with respect to each other, in order for deposition regions corresponding to the patterning slit sheets not to overlap on the substrate 500. In other words, when the first thin film deposition assembly 100, the second thin film deposition assembly 200, and the third thin film deposition assembly 200 are used to deposit the R emission layer, the G emission layer and the B emission layer, respectively, patterning slits 151 of the first thin film deposition assembly 100, patterning slits 251 of the second thin film deposition assembly 200, and patterning slits 351 of the second thin film deposition assembly 300 are arranged not to be aligned with respect to each other, in order to form the R emission layer, the G emission layer and the B emission layer in different regions of the substrate 500.

In addition, the deposition materials for forming the R emission layer, the G emission layer, and the B emission layer may have different deposition temperatures. Therefore, the temperatures of the deposition sources of the respective first, second, and third thin film deposition assemblies 100, 200, and 300 may be set to be different.

Although the thin film deposition assembly according to the current embodiment of the present invention includes three thin film deposition assemblies, the present invention is not limited thereto. In other words, a thin film deposition assembly according to another embodiment of the present invention may include a plurality of thin film deposition assemblies, each of which contains a different deposition material. For example, a thin film deposition assembly according to another embodiment of the present invention may include five thin film deposition assemblies respectively containing materials for forming a R emission layer, a G emission layer, a B emission layer, an auxiliary layer (R′) of the R emission layer, and an auxiliary layer (G′) of the G emission layer.

As described above, a plurality of thin films may be formed concurrently (e.g., at the same time) with a plurality of thin film deposition assemblies, and thus manufacturing yield and deposition efficiency may be improved. In addition, the overall manufacturing process may be simplified, and the manufacturing costs may be reduced.

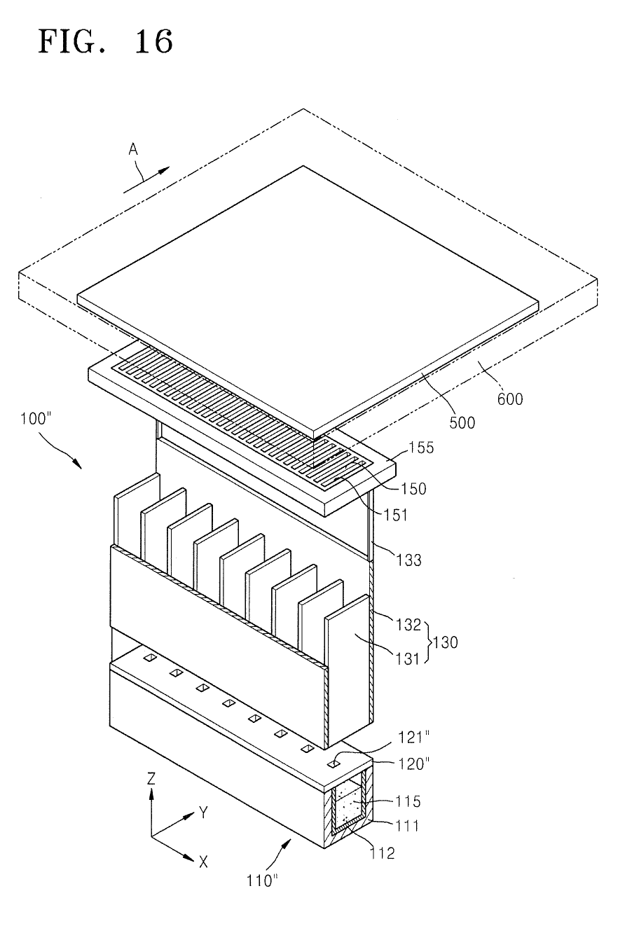

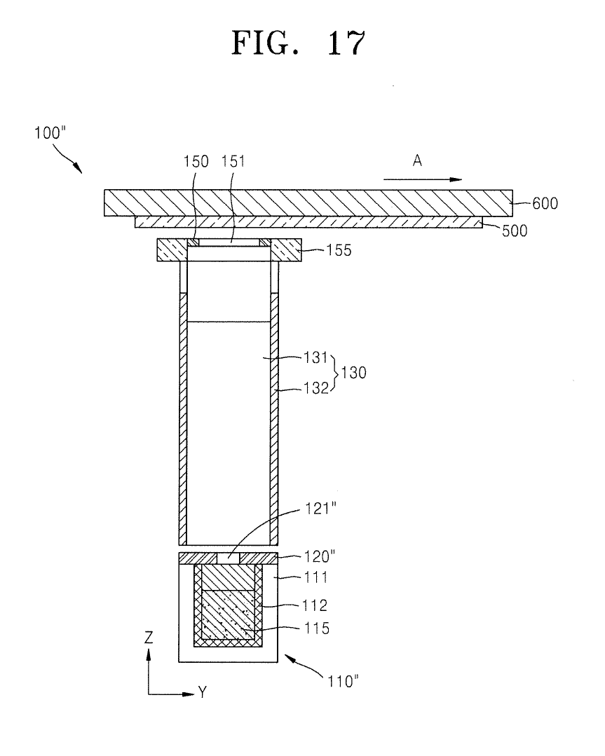

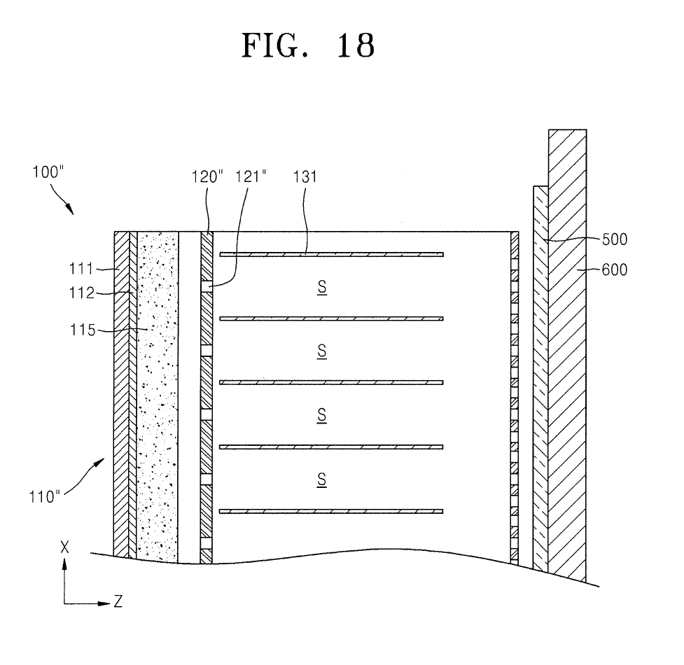

FIG. 16 is a schematic perspective view of a thin film deposition assembly 100″ according to an embodiment of the present invention, FIG. 17 is a schematic sectional side view of the thin film deposition assembly 100″ of FIG. 16, and FIG. 18 is a schematic sectional plan view of the thin film deposition assembly 100″ of FIG. 16.

Referring to FIGS. 16 through 18, the thin film deposition assembly 100″ according to the current embodiment of the present invention includes a deposition source 110″, a deposition source nozzle unit 120″, a barrier plate assembly 130, and patterning slits 151.

Although a chamber is not illustrated in FIGS. 16 through 18 for the convenience of explanation, all the components of the thin film deposition apparatus 100″ may be disposed within a chamber that is maintained at an appropriate degree of vacuum. The chamber is maintained at an appropriate vacuum in order to allow a deposition material to move in a substantially straight line through the thin film deposition apparatus 100″.

In the chamber in which the thin film deposition assembly 100″ may be disposed, the substrate 500, which is a deposition target substrate on which the deposition material 115 is to be deposited, may be transferred by an electrostatic chuck 600. The substrate 500 may be a substrate for flat panel displays. A large substrate, such as a mother glass, for manufacturing a plurality of flat panel displays, may be used as the substrate 500.

In an embodiment, the substrate 500 or the thin film deposition assembly 100″ may be moved relative to the other. For example, the substrate 500 may be moved in a direction of an arrow A, relative to the thin film deposition assembly 100″.

Thus, in the thin film deposition assembly 100″ according to the current embodiment of the present invention, the patterning slit sheet 150 may be smaller (e.g., significantly smaller) than a FMM used in a conventional deposition method. In other words, in the thin film deposition assembly 100″, deposition may be continuously performed, i.e., in a scanning manner while the substrate 500 is moved in the Y-axis direction. Thus, a length of the patterning slit sheet 150 in the Y-axis direction may be less (e.g., significantly less) than a length of the substrate 500 provided that a width of the patterning slit sheet 150 in the X-axis direction and a width of the substrate 500 in the X-axis direction are substantially equal to each other. However, even when the width of the patterning slit sheet 150 in the X-axis direction is less than the width of the substrate 500 in the X-axis direction, deposition may be performed on the entire substrate 500 in a scanning manner while the substrate 500 or the thin film deposition assembly 100″ is moved relative each other.

As described above, since the patterning slit sheet 150 may be formed to be smaller (e.g., significantly smaller) than a FMM used in a conventional deposition method, it is relatively easy to manufacture the patterning slit sheet 150 used in the present invention. In other words, using the patterning slit sheet 150, which is smaller than a FMM used in a conventional deposition method, is more convenient in all processes, including etching and other subsequent processes, such as precise extension, welding, moving, and cleaning processes, compared to the conventional deposition method using the larger FMM. This is more advantageous for a relatively large display device.

The deposition source 110″ that contains and heats the deposition material 115 is disposed at an opposite side of the first chamber 731 in FIG. 1 to a side at which the substrate 500 is disposed.

The deposition source 110″ includes a crucible 112 that may be filled with the deposition material 115, and a cooling block 111 surrounding the crucible 112. The cooling block 111 prevents radiation of heat from the crucible 112 outside, i.e., into the first chamber. The cooling block 111 may include a heater (not shown) that heats the crucible 111.

The deposition source nozzle unit 120″ may be disposed at a side of the deposition source 110″, and in particular, at the side of the deposition source 110″ facing the substrate 500. The deposition source nozzle unit 120″ includes a plurality of deposition source nozzles 121″ arranged at equal intervals in the X-axis direction. The deposition material 115 that may be vaporized in the deposition source 110″ passes through the deposition source nozzles 121″ of the deposition source nozzle unit 120″ towards the substrate 500, which is the deposition target substrate on which the deposition material 115 is to be deposited.

The barrier plate assembly 130 may be disposed at a side of the deposition source nozzle unit 120″. The barrier plate assembly 130 includes a plurality of barrier plates 131, and a barrier plate frame 132 that covers sides of the barrier plates 131. While the barrier plate frame 132 appears in FIG. 16 as including two barrier plate frame plates that have different heights, as shown in FIG. 17, the left and right barrier plate frame plates of the barrier plate frame 132 may have the same height. The plurality of barrier plates 131 may be arranged parallel to each other at equal intervals in the X-axis direction. In addition, each of the barrier plates 131 may be arranged parallel to an YZ plane in FIG. 16, and may have a rectangular shape. The plurality of barrier plates 131 arranged as described above partition the space between the deposition source nozzle unit 120″ and the patterning slit sheet 150 into a plurality of sub-deposition spaces S. In the thin film deposition assembly 100″ according to the current embodiment of the present invention, as illustrated in FIG. 18, the deposition space may be divided by the barrier plates 131 into the sub-deposition spaces S that respectively correspond to the deposition source nozzles 121″ through which the deposition material 115 may be discharged.

Here, the barrier plates 131 may be respectively disposed between adjacent deposition source nozzles 121″. In other words, each of the deposition source nozzles 121″ may be disposed between two adjacent barrier plates 131. The deposition source nozzles 121″ may be respectively located at the midpoint between two adjacent barrier plates 131. However, the present invention is not limited to this structure. For example, a plurality of deposition source nozzles 121″ may be disposed between two adjacent barrier plates 131. In this case, the deposition source nozzles 121″ may be also respectively located at the midpoint between two adjacent barrier plates 131.

As described above, since the barrier plates 131 partition the space between the deposition source nozzle unit 120″ and the patterning slit sheet 150 into the plurality of sub-deposition spaces S, the deposition material 115 discharged through each of the deposition source nozzles 121″ is not mixed with the deposition material 115 discharged through the other deposition source nozzles 121″, and passes through the patterning slits 151 so as to be deposited on the substrate 500. In other words, the barrier plates 131 guide the deposition material 115, which may be discharged through the deposition source nozzles slits 121″, to move straight, not to flow in the X-axis direction.

As described above, the deposition material 115 may be forced to move straight by installing the barrier plates 131, so that a smaller shadow zone may be formed on the substrate 500 compared to a case where no barrier plates are installed. Thus, the thin film deposition assembly 100″ and the substrate 500 can be separated from each other by a distance (e.g., a predetermined distance). This will be described later in detail.

The barrier plate frame 132, which forms sides of the barrier plates 131, maintains the positions of the barrier plates 131, and guides the deposition material 115, which may be discharged through the deposition source nozzles 121″, not to flow in the Y-axis direction.

The deposition source nozzle unit 120″ and the barrier plate assembly 130 may be separated from each other by a predetermined distance. This may prevent the heat radiated from the deposition source unit 110″ from being conducted to the barrier plate assembly 130. However, aspects of the present invention are not limited to this. For example, an appropriate heat insulator (not shown) may be further disposed between the deposition source nozzle unit 120″ and the barrier plate assembly 130. In this case, the deposition source nozzle unit 120″ and the barrier plate assembly 130 may be bound together with the heat insulator therebetween.

In addition, the barrier plate assembly 130 may be constructed to be detachable from the thin film deposition assembly 100″. In the thin film deposition assembly 100″ according to the current embodiment of the present invention, the deposition space may be enclosed by using the barrier plate assembly 130, so that the deposition material 115 that remains undeposited may be mostly deposited within the barrier plate assembly 130. Thus, since the barrier plate assembly 130 may be constructed to be detachable from the thin film deposition assembly 100″, when a large amount of the deposition material 115 lies in the barrier plate assembly 130 after a long deposition process, the barrier plate assembly 130 may be detached from the thin film deposition assembly 100″ and then placed in a separate deposition material recycling apparatus in order to recover the deposition material 115. Due to the structure of the thin film deposition assembly 100″ according to the present embodiment, a reuse rate of the deposition material 115 is increased, so that the deposition efficiency is improved, and thus the manufacturing costs are reduced.

The patterning slit sheet 150 and a frame 155 in which the patterning slit sheet 150 is bound may be disposed between the deposition source 110″ and the substrate 500. The frame 155 may be formed in a lattice shape, similar to a window frame. The patterning slit sheet 150 may be bound inside the frame 155. The patterning slit sheet 150 includes a plurality of patterning slits 151 arranged in the X-axis direction. The patterning slits 151 extend in the Y-axis direction. The deposition material 115 that has been vaporized in the deposition source 110″ and passed through the deposition source nozzles 121″ passes through the patterning slits 151 towards the substrate 500.

The patterning slit sheet 150 may be formed of a metal thin film. The patterning slit sheet 150 may be fixed to the frame 150 such that a tensile force is exerted thereon. The patterning slits 151 may be formed by etching the patterning slit sheet 150 to a stripe pattern.

In the thin film deposition assembly 100″ according to the current embodiment of the present invention, the total number of patterning slits 151 may be greater than the total number of deposition source nozzles 121″. In addition, there may be a greater number of patterning slits 151 than deposition source nozzles 121″ disposed between two adjacent barrier plates 131. The number of patterning slits 151 may be equal to the number of deposition patterns to be formed on the substrate 500.

In addition, the barrier plate assembly 130 and the patterning slit sheet 150 may be disposed to be separated from each other by a distance (e.g., a predetermined distance). Alternatively, the barrier plate assembly 130 and the patterning slit sheet 150 may be connected by a second connection member 133 (as shown in FIG. 16). In more detail, the temperature of the barrier plate assembly 130 may increase to 100° C. or higher due to the deposition source 110″ whose temperature is high. Thus, in order to prevent the heat of the barrier plate assembly 130 from being conducted to the patterning slit sheet 150, the barrier plate assembly 130 and the patterning slit sheet 150 are separated from each other by a distance (e.g., a predetermined distance).

As described above, the thin film deposition assembly 100″ according to the current embodiment of the present invention performs deposition while being moved relative to the substrate 500. In order to move the thin film deposition assembly 100″ relative to the substrate 500, the patterning slit sheet 150 may be separated from the substrate 500 by a distance (e.g., a predetermined distance). In addition, in order to prevent the formation of a relatively large shadow zone on the substrate 500 when the patterning slit sheet 150 and the substrate 500 are separated from each other, the barrier plates 131 are arranged between the deposition source nozzle unit 120″ and the patterning slit sheet 150 to force the deposition material 115 to move in a straight direction. Thus, the size of the shadow zone that may be formed on the substrate 500 is reduced (e.g., sharply reduced).

In particular, in a conventional deposition method using a FMM, deposition may be performed with the FMM in close contact with a substrate in order to prevent formation of a shadow zone on the substrate. However, when the FMM is used in close contact with the substrate, the contact may cause defects, such as scratches on patterns formed on the substrate. In addition, in the conventional deposition method, the size of the mask has to be the same as the size of the substrate since the mask cannot be moved relative to the substrate. Thus, the size of the mask has to be increased as display devices become larger. However, it is not easy to manufacture such a large mask.

In order to overcome this problem, in the thin film deposition assembly 100″ according to the current embodiment of the present invention, the patterning slit sheet 150 may be disposed to be separated from the substrate 500 by a distance (e.g., a predetermined distance). This may be facilitated by installing the barrier plates 131 to reduce the size of the shadow zone formed on the substrate 500.

As described above, when the patterning slit sheet 150 is manufactured to be smaller than the substrate 500, the patterning slit sheet 150 may be moved relative to the substrate 500 during deposition. Thus, it is no longer necessary to manufacture a large FMM as used in the conventional deposition method. In addition, since the substrate 500 and the patterning slit sheet 150 are separated from each other, defects caused due to contact therebetween may be prevented. In addition, since it is unnecessary to contact the substrate 500 with the patterning slit sheet 150 during a deposition process, the manufacturing speed may be improved.

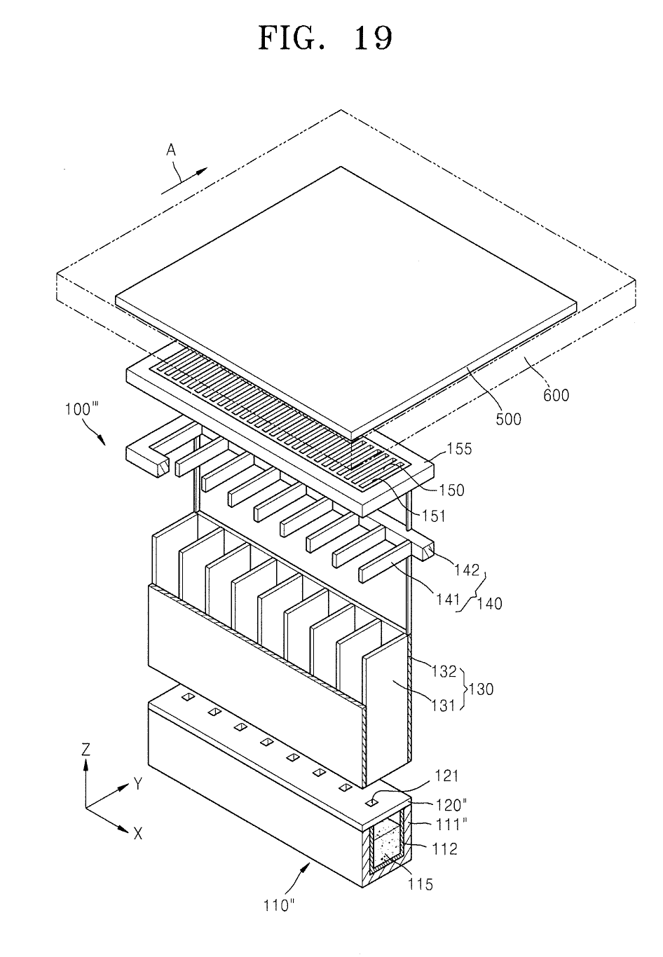

FIG. 19 is a schematic perspective view of a thin film deposition assembly 100′″ according to another embodiment of the present invention.

Referring to FIG. 19, the thin film deposition assembly 100′″ according to the current embodiment of the present invention includes a deposition source 110″, a deposition source nozzle unit 120″, a first barrier plate assembly 130, a second barrier plate assembly 140, and a patterning slit sheet 150.

Although a chamber is not illustrated in FIG. 19 for the convenience of explanation, all the components of the thin film deposition assembly 100′″ may be disposed within a chamber that may be maintained at an appropriate degree of vacuum. The chamber may be maintained at an appropriate vacuum in order to allow a deposition material to move in a substantially straight line through the thin film deposition assembly 100′″.

The substrate 500, which is a deposition target substrate on which a deposition material 115 is to be deposited, may be disposed in the chamber (not shown). The deposition source 110″ that contains and heats the deposition material 115 may be disposed in an opposite side of the chamber (not shown) to a side in which the substrate 500 is disposed.

Structures of the deposition source 110″ and the patterning slit sheet 150 are the same as those in the embodiment described with reference to FIG. 19, and thus a detailed description thereof will not be provided here. The first barrier plate assembly 130 may also be the same as the barrier plate assembly 130 of the embodiment described with reference to FIG. 19, and thus a detailed description thereof will not be provided here.

The second barrier plate assembly 140 may be disposed at a side of the first barrier plate assembly 130. The second barrier plate assembly 140 includes a plurality of second barrier plates 141, and a second barrier plate frame 142 that covers sides of the second barrier plates 141. In FIG. 19, some portions of the second barrier plate assembly 140 are not shown for illustrative purposes. In practice, the second barrier plate frame 142 may surround the second barrier plates 141 or to hold the second barrier plates 141 at least two ends.

The plurality of second barrier plates 141 may be arranged parallel to each other at equal intervals in the X-axis direction. In addition, each of the second barrier plates 141 may be formed to extend in the YZ plane in FIG. 19, i.e., perpendicular to the X-axis direction.

The plurality of first barrier plates 131 and second barrier plates 141 arranged as described above partition the space between the deposition source nozzle unit 120″ and the patterning slit sheet 150. The deposition space may be divided by the first barrier plates 131 and the second barrier plates 141 into sub-deposition spaces that respectively correspond to the deposition source nozzles 121″ through which the deposition material 115 may be discharged.

The second barrier plates 141 may be disposed to correspond respectively to the first barrier plates 131. In other words, the second barrier plates 141 may be respectively disposed to be parallel to and to be on the same plane as the first barrier plates 131. That is, each pair of the corresponding first and second barrier plates 131 and 141 may be located on the same plane. Although the first barrier plates 131 and the second barrier plates 141 are respectively illustrated as having the same thickness in the X-axis direction, aspects of the present invention are not limited thereto. In other words, the second barrier plates 141, which need to be accurately aligned with the patterning slits 151, may be formed to be relatively thin, whereas the first barrier plates 131, which do not need to be precisely aligned with the patterning slits 151, may be formed to be relatively thick. This makes it easier to manufacture the thin film deposition assembly.

As illustrated in FIG. 1, a plurality of thin film deposition assemblies, which each have the same structure as the thin film deposition assembly 100 described above, may be successively disposed in the first chamber 731. In this case, the thin film deposition assemblies 100, 200, 300 and 400 may be used to deposit different deposition materials, respectively. For example, the thin film deposition assemblies 100, 200, 300 and 400 may have different patterning slit patterns, so that pixels (organic emission layers) of different colors, for example, red, green and blue, may be concurrently (e.g., simultaneously) defined through a film deposition process. For example, any suitable combination of the thin film deposition assemblies 100 (of FIGS. 11-13 and 15), 100′ (of FIG. 14), 200, 300 (both of FIG. 15), 100″ (of FIGS. 16-18), and 100′″ (of FIG. 19), may be used as the thin film deposition assemblies 100, 200, 300 and 400 of FIGS. 1 and 2.

The thin film deposition apparatuses according to the embodiments of the present invention described above may be applied to form an organic layer or an inorganic layer of an organic TFT, and to form layers from various materials.

According to the above embodiments of the present invention, since the organic emission layer may be removed during the in-line process, the fabrication processes of the organic light-emitting display device may be simplified, and the manufacturing yield of the organic light-emitting display device may be improved.

While the present invention has been particularly shown and described with reference to exemplary embodiments thereof, it will be understood by those of ordinary skill in the art that various changes in form and details may be made therein without departing from the spirit and scope of the present invention as defined by the following claims and their equivalents.

What is claimed is:

1. A method of manufacturing an organic light-emitting display device, the method comprising:
preparing a substrate that includes a plurality of first regions and a second region surrounding the plurality of first regions;
conveying the substrate into a chamber;
forming an organic emission layer in a direction on a surface of the substrate;
forming a first metal layer on the organic emission layer so as to correspond to the plurality of first regions; and
removing the organic emission layer formed on the second region.

2. The method of claim 1, wherein the first metal layer is a common electrode, and protects the organic emission layer formed on the first regions when the organic emission layer formed on the second region is removed.

3. The method of claim 1, wherein in the removing of the organic emission layer,
the organic emission layer formed on the second region is removed by a plasma etching process, an ultraviolet (UV)-ozone process, or a laser ablation process.

4. The method of claim 1, further comprising:
covering the first metal layer by using a shielding plate, after forming the first metal layer and before removing the organic emission layer.

5. The method of claim 4, wherein the shielding plate covers the first metal layer and exposes the organic emission layer formed on the second region.

6. The method of claim 4, wherein the shielding plate is formed of a metal plate or a non-metal plate, and covers the first metal layer formed on the plurality of first regions.

7. The method of claim 4, wherein in the removing of the organic emission layer, the organic emission layer formed on the second region in a state where the shielding plate covers the first metal layer.

8. The method of claim 7, wherein the shielding plate is removed after removing the organic emission layer.

9. The method of claim 8, wherein a second metal layer is formed on the first metal layer after removing the shielding plate.

10. The method of claim 9, wherein the second metal layer is a common electrode.

11. The method of claim 1, wherein the forming of the organic emission layer is performed by using a thin film deposition assembly disposed in the chamber, and the organic emission layer is formed on the substrate by a relative movement of the substrate with respect to the thin film deposition assembly.

12. The method of claim 1, wherein the forming of the organic emission layer is performed on the substrate continuously by a plurality of thin film deposition assemblies that are disposed in the chamber.

13. The method of claim 11, wherein the thin film assembly comprises:
a deposition source that discharges a deposition material;
a deposition source nozzle unit disposed at a side of the deposition source and including a plurality of deposition source nozzles arranged in a first direction; and
a patterning slit sheet disposed opposite to the deposition source nozzle unit and having a plurality of patterning slits arranged in a second direction perpendicular to the first direction,
wherein the deposition source, the deposition source nozzle unit, and the patterning slit sheet are integrally formed as one body,
and the thin film deposition assembly is separated from the substrate, and deposition is performed while the substrate or the thin film deposition assembly is moved relative to the other in the first direction.

14. The method of claim 13, wherein the deposition source and the deposition source nozzle unit, and the patterning slit sheet are integrally connected as one body by a connection member that guides flow of the deposition material.

15. The method of claim 14, wherein the connection member seals a space between the deposition source nozzle unit disposed at the side of the deposition source, and the patterning slit sheet.

16. The method of claim 13, wherein the plurality of deposition source nozzles are formed to be tilted at an angle.

17. The method of claim 16, wherein the plurality of deposition source nozzles include deposition source nozzles arranged in two rows formed in the first direction, and the deposition source nozzles in the two rows are tilted to face each other.

18. The method of claim 16, wherein the plurality of deposition source nozzles includes deposition source nozzles arranged in two rows formed in the first direction,
the deposition source nozzles of a row located at a first side of the patterning slit sheet are arranged to face a second side of the patterning slit sheet, and
the deposition source nozzles of the other row located at the second side of the patterning slit sheet are arranged to face the first side of the patterning slit sheet.

19. The method of claim 11, wherein the thin film deposition assembly comprises:
a deposition source discharging a deposition material;
a deposition source nozzle unit disposed at a side of the deposition source and including a plurality of deposition source nozzles arranged in a first direction;
a patterning slit sheet disposed opposite to the deposition source nozzle unit and having a plurality of patterning slits arranged in the first direction; and
a barrier plate assembly comprising a plurality of barrier plates that are disposed between the deposition source nozzle unit and the patterning slit sheet in the first direction, and partition a space between the deposition source nozzle unit and the patterning slit sheet into a plurality of sub-deposition spaces,
wherein the thin film deposition assembly is separated from the substrate, and deposition is performed while the substrate or the thin film deposition assembly is moved relative to the other.

20. The method of claim 19, wherein each of the plurality of barrier plates extends in a second direction substantially perpendicular to the first direction.

21. The method of claim 19, wherein the barrier plate assembly comprises a first barrier plate assembly comprising a plurality of first barrier plates, and a second barrier plate assembly comprising a plurality of second barrier plates.

22. The method of claim 21, wherein each of the first barrier plates and each of the second barrier plates extend in the second direction substantially perpendicular to the first direction.

23. The method of claim 22, wherein the plurality of first barrier plates are arranged to respectively correspond to the plurality of second barrier plates.

24. The method of claim 19, wherein the deposition source and the barrier plate assembly are separated from each other.

25. The method of claim 19, wherein the barrier plate assembly and the patterning slit sheet are separated from each other.
